(19) United States
(12) Patent Application Publication
(10) Pub. No.: US 2026/0138356 A1
(43) Pub. Date: May 21, 2026

(54) TUNABLE MULTI-LAYER MATERIALS FOR ENERGY DAMPING AND VIBRATION DISSIPATION

(71) Applicant: CASE WESTERN RESERVE UNIVERSITY, Cleveland, OH (US)

(72) Inventors: Gary Wnek, Cleveland, OH (US); Zachary Baierl, University Heights, OH (US)

(21) Appl. No.: 19/377,727

(22) Filed: Nov. 3, 2025

Related U.S. Application Data
(60) Provisional application No. 63/714,971, filed on Nov. 1, 2024.

(51) Int. Cl. B32B 25/08; B29C 48/21; B29C 51/00; B29C 51/02; B29C 51/14; B29K 105/24; B32B 37/10; B32B 37/15

(52) U.S. Cl. CPC B32B 25/08; B29C 48/21; B29C 51/002; B29C 51/02; B29C 51/14; B32B 37/10; B32B 37/153; B29K 2105/246; B29K 2995/0002; B32B 2250/03; B32B 2250/24; B32B 2250/40; B32B 2305/72; B32B 2307/102; B32B 2307/738

(57) ABSTRACT

A multilayer material includes a plurality of energy-damping and/or vibration dissipation overlapping polymer layers, wherein at least two physically cross-linked thermoplastic polymer layers or chemically cross-linked rubber layers confine at least one uncross-linked rubber layer to inhibit flow of the at least one uncross-linked rubber layer from the multilayer material under load and/or stress.

### RELATED APPLICATION

This application claims priority from U.S. Provisional Application No. 63/714,971, filed Nov. 1, 2024, the subject matter of which is incorporated herein by reference in its entirety.

### GOVERNMENT FUNDING

This invention was made with government support under W911NF-20-2-0155 awarded by the Department of Defense. The government has certain rights in the invention.

### BACKGROUND

There is a great need for impact energy-absorbing materials across a wide range of applications, including sports equipment (primarily helmets and mouth guards), soldier protective gear, mitigation of the results of fall by the elderly (head bands, hip pads, and floor mats), insoles for shoes, and vibration-damping packaging for sensitive electronic components in, for example, automobiles, and acoustic damping in industries with high audio noise. In the tire industry, the composition of the rubbery tire material is judiciously adjusted to meet a broad range of performance needs that conflict with each other. For example, good rolling resistance would benefit from a less flexible rubber, whereas wet traction requires a softer material. This is typically accomplished by blending of multiple components with different energy loss characteristics, characterized in the field of rubbers as tangent delta, or more commonly tan δ.

This is the ratio of loss to storage moduli of a material, and is a maximum around the softening temperature, or more formally the glass transition temperature or Tg. As an example, the desirable frequency range for vibration damping in automobiles is 5-15 Hz.

### SUMMARY

Embodiments described herein relate to a tunable multi-layer material for use in energy-damping and vibration dissipation. The multilayer material can include a plurality of energy-damping and/or vibration dissipation overlapping polymer layers. The plurality of energy-damping and/or vibration dissipation overlapping polymer layers can include at least two physically cross-linked thermoplastic polymer layers or chemically cross-linked rubber layers that confine at least one uncross-linked rubber layer to inhibit flow or creep of the at least one uncross-linked rubber layer from the multilayer material under load and/or stress at the operating temperature, e.g., about −40° C. to about 50° C., of the tunable multilayer material.

In some embodiments, the plurality of energy-damping and/or vibration dissipation overlapping polymer layers include at least two physically cross-linked thermoplastic elastomer layers or chemically cross-linked rubber layers that confine the at least one uncross-linked rubber layer.

In some embodiments, the physically cross-linked thermoplastic elastomer layers and uncross-linked rubber layers can each have loss tangents (tan Ss) that are substantially the same or different at temperatures of about −40° C. to about 50° C.

In some embodiments, the physically cross-linked thermoplastic elastomer layers include at least one of a thermoplastic styrenic elastomer (TPS), a thermoplastic polyolefin elastomer (TPO), a thermoplastic polyurethane (TPU), a thermoplastic copolyester (TPC), a thermoplastic polyamide (TPA), or silicone copolymer elastomer.

In some embodiments, the thermoplastic styrenic elastomer can include a styrenic block copolymer, such as a styrene-butadiene-styrene (SBS) copolymer, a styrene-ethylene-butylene-styrene (SEBS), a styrene-isoprene-styrene (SIS) copolymer, a styrene-ethylene-propylene-styrene (SEPS), a styrene-isobutylene-styrene (SIBS) copolymer, a styrene-isobutylene copolymer, or a styrene-ethylene-ethylene-propylene-styrene (SEEPS) block copolymer.

In some embodiments, the at least one uncross-linked rubber layer includes at least one of an uncross-linked natural rubber (NR) or a fully unvulcanized synthetic rubber.

In some embodiments, the fully unvulcanized synthetic rubber includes at least one of an isobutylene-isoprene rubber, a styrene butadiene rubber, an isoprene rubber, an acrylonitrile butadiene rubber, a butadiene rubber, a chloroprene rubber, an ethylene propylene rubber, an ethylene propylene diene rubber, polyisobutylene rubber, or a silicone rubber.

In some embodiments, the multilayer material can include a stack of alternating overlapping physically cross-linked thermoplastic polymer layers or chemically cross-linked rubber layers and uncross-linked rubber layers. Underlying and overlying physically cross-linked polymer layers or chemically cross-linked rubber layers of the stack can sandwich or confine at least one uncross-linked rubber layer to inhibit creep or flow of the at least one uncross-linked rubber layer from the stack under load and/or stress.

In some embodiments, the stack can include about 3 to about 100,000 layers.

In some embodiments, adjoining physically cross-linked thermoplastic polymer layers or chemically cross-linked rubber layers and uncross-linked rubber layers can define generally planar interfaces therebetween.

In other embodiments, the interfaces and/or layers can further include at least one organic/inorganic filler.

In some embodiments, the multilayer material can include at least one adhesive or tie layer or surface layer for additional functionalities.

In some embodiments, the multilayer material, which is devoid of a chemically cross-linked polymer layer, can be thermoformable into various shapes.

Other embodiments described herein relate to an energy-damping and/or vibration dissipation material that includes a multilayer material as described herein.

Still other embodiments described herein relate to a method of forming an energy-damping and/or vibration dissipation material. The method can include confining at least one uncross-linked rubber film between at least two physically cross-linked thermoplastic polymer films or cross-linked rubber films to form a multilayer material. The multilayer material can include at least two physically cross-linked thermoplastic polymer layers or chemically cross-linked rubber layers that inhibit creep or flow of at least one confined uncross-linked rubber layer from the multilayer material under load and/or stress.

In some embodiments, an unconfined rubber film can undergo flow or creep under load and/or stress at the operating temperature, e.g., about −40° C. to about 50° C., of the energy-damping and/or vibration dissipation material.

In some embodiments, the at least one uncross-linked rubber film and the least two physically cross-linked thermoplastic polymer films or cross-linked rubber films are formed by at least one of solution-based methods, melt processing, vapor deposition methods, emulsion or dispersion-based methods, or additive methods.

In some embodiments, the at least one uncross-linked rubber film can be confined between the at least two physically cross-linked thermoplastic polymer films or chemically cross-linked rubber films by stacking the at least one uncross-linked rubber film between the at least two physically cross-linked thermoplastic polymer films or cross-linked rubber films and consolidating the stacked films under pressure to obtain a flat multilayer material.

In some embodiments, an inorganic/organic filler can be dusted on at least one surface of the stacked films.

In other embodiment, the at least one uncross-linked rubber film can be confined between the at least two physically cross-linked thermoplastic polymer films by extruding the at least one uncross-linked rubber film and the at least two physically cross-linked thermoplastic polymer films and consolidating the stacked films or coextruding the at least one uncross-linked rubber film and the physically cross-linked thermoplastic polymer film and optionally multiplying the coextruded films to obtain a flat multilayer material.

In some embodiments, the stacked films can be heat-sealed, patterned, compressed, or stamped to enhance strength, reduce creep, and/or provide energy dissipation paths in the multilayer material.

In some embodiments, the method can further include shaping multilayer materials that are not chemically cross-linked by thermoforming the multilayer material.

In some embodiments, the method can further include cross-linking at least a portion of the uncross-linked rubber film and/or the physically cross-linked thermoplastic polymer films after confining the uncross-linked rubber film. For example, at least a portion of the uncross-linked rubber film and/or the physically cross-linked thermoplastic polymer films can be cross-linked after thermoforming.

In some embodiments, the crosslinking can be achieved by activating reactive additives or exposure to, for example, high-energy radiation, including electron beams or gamma rays.

In some embodiments, the physically cross-linked thermoplastic polymer layers and uncross-linked rubber layer each have loss tangents (tan δs) that are substantially the same or different at temperatures of about −40° C. to about 50° C.

In some embodiments, the at least one physically cross-linked thermoplastic polymer film can be a physically cross-linked thermoplastic elastomer selected from a thermoplastic styrenic elastomer (TPS), a thermoplastic polyolefin elastomer (TPO), a thermoplastic polyurethane (TPU), a thermoplastic copolyester (TPC), a thermoplastic polyamide (TPA), or silicone copolymer elastomer.

In some embodiments, the thermoplastic styrenic elastomer (TPS) can include a styrenic block copolymer, such as a styrene-butadiene-styrene (SBS) copolymer, a styrene-ethylene-butylene-styrene (SEBS), a styrene-isoprene-styrene (SIS) copolymer, a styrene-ethylene-propylene-styrene (SEPS), a styrene-isobutylene-styrene (SIBS) copolymer, a styrene-isobutylene copolymer, or a styrene-ethylene-ethylene-propylene-styrene block copolymer.

In some embodiments, the at least one uncross-linked rubber film can include at least one of an uncross-linked natural rubber (NR) or a fully unvulcanized synthetic rubber.

In some embodiments, the fully unvulcanized synthetic rubber can include at least one of an isobutylene-isoprene rubber, a styrene butadiene rubber, an isoprene rubber, an acrylonitrile butadiene rubber, a butadiene rubber, a chloroprene rubber, an ethylene propylene rubber, an ethylene propylene diene rubber, polyisobutylene rubber, or a silicone rubber.

Other embodiments described herein relate to an energy-damping and/or vibration dissipation material, formed by the methods described herein.

### BRIEF DESCRIPTION OF THE DRAWINGS

FIG. 1 is a schematic of multilayer material comprising a plurality of energy-damping and/or vibration dissipation overlapping polymer layers in accordance with an embodiment.

FIG. 2 is a schematic of multilayer material comprising a plurality of energy-damping and/or vibration dissipation overlapping polymer layers in accordance with another embodiment.

FIG. 3 is a flow diagram of a method of forming an energy-damping and/or vibration dissipation material in accordance with an embodiment.

FIG. 4 illustrates an extrusion and multiplying system in accordance with an embodiment.

FIG. 5 illustrates an image showing preparation of a film via melt-pressing.

FIG. 6(A-E) illustrate images showing a process of creating a multilayer film via hot compaction.

FIG. 7(A-C) illustrate images showing (A) a melt-processed trilayer film of coextruded thermoplastic polymer, (B) high-density polyethylene (HDPE), and (C) unvulcanized butyl rubber.

FIG. 8(A-C) illustrate: (A) 200× scanning electron microscope (SEM) image of a cryofracture surface of a SIBS A: Butyl Trilayer; (B) a 2000× scanning electron microsope (SEM) image of the sample of (A) demonstrating the neat interface between the materials; and (C) a 2000× scanning electron microsope (SEM) image of the interface of a trilayer sample that has been intentionally dusted with a metal-organic framework (MOF).

FIG. 9 illustrates plots showing the averaged tensile properties of two different grades of the thermoplastic elastomer SIBS and an unvulcanized butyl tested using ASTM D412.

FIG. 10 illustrates plots showing the averaged tensile properties of the thermoplastic elastomer SIBS B and butyl trilayer system tested using ASTM D412.

FIG. 11 illustrates plots showing the averaged tensile properties of the thermoplastic elastomer SIBS A and butyl trilayer system tested using ASTM D412.

FIG. 12 illustrates plots showing the averaged tensile properties of the thermoplastic elastomer SIS and NR trilayer family tested using ASTM D412.

FIG. 13 illustrates plots showing measured adhesion data between SIBS A and butyl using T-peel testing.

FIG. 14 illustrates a graph showing measured adhesion data between SIBS B and butyl using T-peel testing.

FIG. 15 illustrates averaged curves of the data found in FIG. 13 and FIG. 14.

FIG. 16 illustrates a graph showing exponential damping rate of several film compositions using SIBS B and butyl across a month of aging gathered using a custom ball drop tower.

FIG. 17 illustrates plots showing dynamic mechanical analysis temperature sweeps of the thermoplastic elastomer SIBS B and butyl trilayer system.

FIG. 18 illustrates plots showing the dynamic mechanical analysis temperature sweeps of the thermoplastic elastomer SIBS A and butyl trilayer system.

FIG. 19 illustrates plots extracted tan δ peak temperature values from FIG. 17 and FIG. 18 plotted against the volume percentage of the unvulcanized butyl.

FIG. 20 illustrates plots showing extracted peak tan δ values from FIG. 17 and FIG. 18 plotted against the volume percentage of the unvulcanized butyl.

FIG. 21 illustrates plots showing extracted tan δ values at room temperature from FIG. 17 and FIG. 18 plotted against the volume percentage of the unvulcanized butyl.

FIG. 22 illustrates an image of a trilayer film of thermoplastic elastomer SIBS B, which has been heated up to about the Tg of the styrene blocks and has been subsequently drawn over a small steel cylinder.

FIG. 23 illustrates plots showing peak linear acceleration data as recorded by a higher-energy impact approximating a personal fall or collision.

FIG. 24 illustrates plots showing the compiled exponential damping rate data of two material families (SIBS:Butyl and SIS:NR) as gathered using a custom ball drop tower.

### DETAILED DESCRIPTION

For convenience, certain terms employed in the specification, examples, and appended claims are collected here. Unless defined otherwise, all technical and scientific terms used herein have the same meaning as commonly understood by one of ordinary skill in the art to which this application belongs.

The articles “a” and “an” are used herein to refer to one or to more than one (i.e., to at least one) of the grammatical object of the article. By way of example, “an element” means one element or more than one element.

The terms “comprise,” “comprising,” “include,” “including,” “have,” and “having” are used in the inclusive, open sense, meaning that additional elements may be included. The terms “such as”, “e.g.,”, as used herein are non-limiting and are for illustrative purposes only. “Including” and “including but not limited to” are used interchangeably.

The term “or” as used herein should be understood to mean “and/or”, unless the context clearly indicates otherwise.

The term “about” or “approximately” refers to a quantity, level, value, number, frequency, percentage, dimension, size, amount, weight or length that varies by as much as 15%, 10%, 9%, 8%, 7%, 6%, 5%, 4%, 3%, 2% or 1% to a reference quantity, level, value, number, frequency, percentage, dimension, size, amount, weight or length. In one embodiment, the term “about” or “approximately” refers a range of quantity, level, value, number, frequency, percentage, dimension, size, amount, weight or length ±15%, +10%, ±9%, ±8%, ±7%, ±6%, ±5%, ±4%, ±3%, ±2%, or ±1% about a reference quantity, level, value, number, frequency, percentage, dimension, size, amount, weight or length.

As used herein, “one or more of a, b, and c” means a, b, c, ab, ac, bc, or abc. The use of “or” herein is the inclusive or.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

Embodiments described herein relate to an energy-damping and vibration dissipation material, and particularly to a tunable energy-damping and vibration dissipation multi-layer material and methods of forming the tunable energy-damping and vibration dissipation multilayer material. We found that it is possible to layer various types of thermoplastic polymer and rubbery materials with different tan δ's to tune the range of frequencies for maximum impact damping or vibration dissipation, given specific application needs. This layering methodology can be useful in targeting other desirable properties in the final product (tactility, printability, barrier, etc.). Overall, this has multiple benefits with the first being that such an approach does not require curing into a thermoset. This lack of curing makes such materials attractive from a sustainability perspective in that chemically-cross-linked systems are not readily separable commercially. Although emergent technologies show promise, uncross-linked systems can typically be separated with less energy-intensive methods.

The layered materials can comprise physically-rather than chemically-cross-linked elastomer layers and uncross-linked rubber layers, where the latter is confined by the physically cross-linked layers to mitigate or inhibit attempts for such materials to flow or creep at the operating temperature, about −40° C. to about 50° C., of the layered material without any additional chemistry. Additional combinations of materials (engineering thermoplastics, inorganic/organic fillers, etc.) may be useful in more elaborate composite structures to target specific applications. Another benefit is in the thermoformability of these systems. Since the multilayers are not chemically constrained, they can be thermoformed using traditional methods to create complicated shapes. These systems can be designed with subsequent post processing steps to retain shape in mind. These can range from stitching and crimping techniques to chemical crosslinking, with trade-offs in sustainability. However, this allows for significant processing flexibility and ultimately more specialized shapes and products.

Multilayer materials with a few, e.g., about 3 to about 10, layers can be made by hot-pressing films of the desired components with a range of tan δ's together, with attention to good adhesion between layers. Optionally, multilayer materials with many more layers can be formed using multi-layer coextrusion capabilities. This provides a significant advantage over traditional rubber processing as continuous film production can potentially reduce the need for batch processing steps.

In some embodiments, the damping performances of the multilayer material and it component layers can be described in terms of their composite loss factor (CLF) properties. The composite loss factor of a material or device is a measure of its ability to convert vibrational energy to thermal energy. As a general practice, the materials or compositions of individual layers selected as being highly damping can have composite loss factors of 0.8 or larger. In a layered construction, the total composite loss factor of the overall construction is generally considered effective at values of 0.05 or larger. The composite loss factor of the multilayer damping laminate can be determined, for example, as described in the standard protocol ASTM E756-05 (2017). The disclosed multilayer materials described herein can have a composite loss factor at 200 Hz that is greater than about 0.050, e.g., greater than about 0.060, greater than about 0.070, greater than about 0.080, greater than about 0.090, greater than about 0.100, greater than about 0.200, greater than about 0.300, greater than about 0.400, or greater than about 0.500.

In some embodiments, a tunable multi-layer material for use in energy-damping and vibration dissipation can include a plurality of energy-damping and/or vibration dissipation overlapping polymer layers. The plurality of energy-damping and/or vibration dissipation overlapping polymer layers can include at least two physically cross-linked thermoplastic polymer layers or chemically cross-linked rubber layers that confine at least one uncross-linked rubber layer to inhibit flow or creep of the at least one uncross-linked rubber layer from the multilayer material under load and/or stress at the operating temperature, e.g., about −40° C. to about 40° C., of the tunable multilayer material.

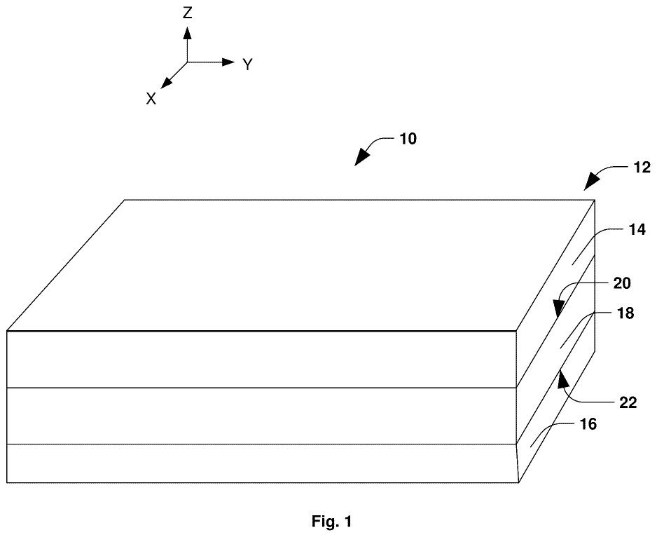

For example, FIG. 1 illustrates a tunable multilayer material 10 for use in energy-damping and vibration dissipation in accordance with an embodiment. The tunable multilayer material 10 can include a stack of a plurality of energy-damping and/or vibration dissipation overlapping polymer layers 12. The plurality of energy-damping and/or vibration dissipation overlapping polymer layers 12 can include a first physically cross-linked thermoplastic polymer layer or chemically cross-linked rubber layer 14 and a second physically cross-linked thermoplastic polymer layer or chemically cross-linked rubber layer 16 that sandwich and/or confine an uncross-linked rubber layer 18 to inhibit flow or creep of the uncross-linked rubber layer 18 from the multilayer material 10 under load and/or stress at the operating temperature, e.g., about −40° C. to about 40° C., of the tunable multilayer material 10.

Adjoining surfaces of respectively the first physically cross-linked thermoplastic polymer layer or chemically cross-linked rubber layer 14 and the uncross-linked rubber layer 18 as well as adjoining surfaces of the second physically cross-linked thermoplastic polymer layer or chemically cross-linked rubber layer 16 and the uncross-linked rubber layer 18 can define generally planar interfaces 20 and 22 therebetween, which lie generally in substantially parallel x-y planes of an x-y-z coordinate system. For example, the first physically cross-linked thermoplastic polymer layer or chemically cross-linked rubber layer 14, the uncross-linked rubber layer 18, and the second physically cross-linked thermoplastic polymer layer or chemically cross-linked rubber layer 16 can be stacked vertically such that adjoining surfaces of the uncross-linked rubber layer 18, and the second physically cross-linked thermoplastic polymer layer or chemically cross-linked rubber layer 16 can define a horizontal planar interface 20 between the adjoining layers 14 and 18, and a horizontal planar interface 22 between the adjoining layers 16 and 18. The multilayer material 10 can include a stack of discrete energy-damping and/or vibration dissipation polymer layers 12 with polymer layer interfaces extending transverse to the x-y plane or horizontal to the vertical stack defined by the first physically cross-linked thermoplastic polymer layer or chemically cross-linked rubber layer 14, the uncross-linked rubber layer 18 and the second physically cross-linked thermoplastic polymer layer or chemically cross-linked rubber layer 16.

In some embodiments, the first physically cross-linked thermoplastic polymer layer or chemically cross-linked rubber layer 14 and the second physically cross-linked thermoplastic polymer layer or chemically cross-linked rubber layer 18 can be formed from the same or different physically cross-linked thermoplastic elastomers or chemically cross-linked rubbers. By physically cross-linked thermoplastic elastomer, it is meant that a thermoplastic elastomer is physically cross-linked but not chemically cross-linked. By chemically cross-linked rubber it is meant that the rubber is at least partially vulcanized or chemically cross-linked to inhibit flow or creep of the rubber.

The physically cross-linked thermoplastic elastomer layers can include at least one of a thermoplastic styrenic elastomer (TPS), a thermoplastic polyolefin elastomer (TPO), a thermoplastic polyurethane (TPU), a thermoplastic copolyester (TPC), a thermoplastic polyamide (TPA), or silicone copolymer elastomer.

In some embodiments, the thermoplastic styrenic elastomer (TPS) can be a styrenic block copolymer. Examples of styrenic block copolymers can includes at least one of a styrene-butadiene-styrene (SBS) copolymer, a styrene-ethylene-butylene-styrene (SEBS), a styrene-isoprene-styrene (SIS) copolymer, a styrene-ethylene-propylene-styrene (SEPS), a styrene-isobutylene-styrene (SIBS) copolymer, a styrene-isobutylene copolymer, or a styrene-ethylene-ethylene-propylene-styrene (SEEPS) block copolymer.

In some embodiments, the chemically cross-linked rubbers can include at least one at least partially vulcanized or cross-linked natural rubber (NR) or synthetic rubber. The at least partially vulcanized or cross-linked synthetic rubber can include, for example, at least partially vulcanized or cross-linked diene type rubber and hydrogenated forms thereof, such as isoprene rubber (IR), epoxidated natural rubber, styrene butadiene rubber (SBR), butadiene rubber (BR) (high cis BR and low cis BR), acrylonitrile-butadiene rubber (NBR), hydrogenated NBR, hydrogenated SBR; olefin type rubber, such as ethylene propylene diene ethylene propylene monomer rubber (EPDM) or ethylene propylene monomer rubber (EPM), maleic acid modified ethylenepropylene rubber (M-EPM), butyl rubber or a isobutylene isoprene rubber (IIR), a copolymer of isobutylene and aromatic vinyl or diene type monomer, acrylic rubber (ACM); halogen containing rubber such as Br-IIR, Cl-IIR, bromide of a isobutylene paramethyl styrene copolymer (Br-IPMS), chloroprene rubber (CR), hydrin rubber (CHR), chloro-sulfonated polyethylene (CSM), chlorinated polyethylene (CM), maleic acid modified chlorinated polyethylene (M-CM); silicone rubber, such as methylvinyl silicone rubber, dimethyl silicone rubber, methylphenyl vinyl silicone rubber; sulfur containing rubber, such as polysulfide rubber; fluorine rubber, such as vinylidene fluoride type rubber, fluorine containing vinyl ether type rubber, tetrafluoroethylene-propylene type rubber, fluorine containing silicone type rubber, fluorine containing phosphazene type rubber, urethane rubber, epichlorohydrin rubber, and the like. These natural rubber or synthetic rubber can be at least partially vulcanized or cross-linked by, for example, sulfur vulcanization, peroxide cross-linking, phenol crosslinking, radiation crosslinking, metal oxide crosslinking, or moisture curing.

The first physically cross-linked thermoplastic polymer layer or chemically cross-linked rubber layer 14 and the second physically cross-linked thermoplastic polymer layer or chemically cross-linked rubber layer 18 can be formed from the same or different physically cross-linked thermoplastic elastomers or chemically cross-linked rubbers and can have substantially the same, similar, or different loss tangents (tan δ) over the operating temperature, e.g., about −40° C. to about 50° C., of the multilayer material to vary or tune the impact energy absorption or damping and vibration dissipation of the multilayer material. For example, the first physically cross-linked thermoplastic polymer layer or chemically cross-linked rubber layer 14 and the second physically cross-linked thermoplastic polymer layer or chemically cross-linked rubber layer 18 can have substantially the same or similar tan δs of less about 0.4 at about 25° C., for example, a tan δ is about 0.01 to about 0.4 at about 25° C., preferably, about 0.01 to about 0.3 at about 25° C., or about 0.01 to about 0.2 at about 25° C. Alternatively, the first physically cross-linked thermoplastic polymer layer or chemically cross-linked rubber layer 14 and the second physically cross-linked thermoplastic polymer layer or chemically cross-linked rubber layer 18 can have substantially different tan Ss to exhibit damping characteristics in a range of frequencies from others.

The uncross-linked rubber layer 18 confined by the first physically cross-linked thermoplastic polymer layer or chemically cross-linked rubber layer 14 and the second physically cross-linked thermoplastic polymer layer or chemically cross-linked rubber layer 16 can include at least one of an uncross-linked natural rubber (NR) or a fully unvulcanized synthetic rubber. The uncross-linked natural rubber (NR) or a fully unvulcanized synthetic rubber when not confined by the first physically cross-linked thermoplastic polymer layer or chemically cross-linked rubber layer 14 and the second physically cross-linked thermoplastic polymer layer or chemically cross-linked rubber layer 16 can undergo flow or creep under load and/or stress at the operating temperature, e.g., about −40° C. to about 40° C., of the energy-damping and/or vibration dissipation material.

In some embodiments, the fully unvulcanized synthetic rubber can include, for example, fully unvulcanized diene type rubber and hydrogenated forms thereof, such as isoprene rubber (IR), epoxidated natural rubber, styrene butadiene rubber (SBR), butadiene rubber (BR) (high cis BR and low cis BR), acrylonitrile-butadiene rubber (NBR), hydrogenated NBR, hydrogenated SBR; olefin type rubber, such as ethylene propylene diene ethylene propylene monomer rubber (EPDM) or ethylene propylene monomer rubber (EPM), maleic acid modified ethylenepropylene rubber (M-EPM), butyl rubber or a isobutylene isoprene rubber (IIR), a copolymer of isobutylene and aromatic vinyl or diene type monomer, acrylic rubber (ACM); halogen containing rubber such as Br-IIR, CI-IIR, bromide of a isobutylene paramethyl styrene copolymer (Br-IPMS), chloroprene rubber (CR), hydrine rubber (CHR), chloro-sulfonated polyethylene (CSM), chlorinated polyethylene (CM), maleic acid modified chlorinated polyethylene (M-CM); silicone rubber, such as methylvinyl silicone rubber, dimethyl silicone rubber, methylphenyl vinyl silicone rubber; sulfur containing rubber, such as polysulfide rubber; fluorine rubber, such as vinylidene fluoride type rubber, fluorine containing vinyl ether type rubber, tetrafluoroethylene-propylene type rubber, fluorine containing silicone type rubber, fluorine containing phosphazene type rubber, urethane rubber, epichlorohydrin rubber, and the like.

In other embodiments, the fully unvulcanized synthetic rubber can include at least one of fully unvulcanized isobutylene-isoprene rubber, a styrene butadiene rubber, an isoprene rubber, an acrylonitrile butadiene rubber, a butadiene rubber, a chloroprene rubber, an ethylene propylene rubber, an ethylene propylene diene rubber, polyisobutylene rubber, or a silicone rubber.

The confined uncross-linked rubber layer 18 and the first physically cross-linked thermoplastic polymer layer or chemically cross-linked rubber layer 14 and/or the second physically cross-linked thermoplastic polymer layer or chemically cross-linked rubber layer 16 can have substantially the same, similar, different loss tangents (tan δ) over the operating temperature, e.g., about −40° C. to about 40° C., of the multilayer material to vary or tune the impact energy absorption and vibration damping of the multilayer material. For example, the confined uncross-linked rubber layer 18 and the first physically cross-linked thermoplastic polymer layer or chemically cross-linked rubber layer 14 and/or the second physically cross-linked thermoplastic polymer layer or chemically cross-linked rubber layer 16 can have substantially the same or similar tan δs of less about 0.4 at about 25° C., for example, a tan δ is about 0.01 to about 0.4 at about 25° C., preferably, about 0.01 to about 0.3 at about 25° C., or about 0.01 to about 0.2 at about 25° C. Alternatively, the confined uncross-linked rubber layer 18 and the first physically cross-linked thermoplastic polymer layer or chemically cross-linked rubber layer 14 and/or the second physically cross-linked thermoplastic polymer layer or chemically cross-linked rubber layer 16 can have substantially different tan Ss to exhibit damping characteristics in a range of frequencies from others.

The first physically cross-linked thermoplastic polymer layer or chemically cross-linked rubber layer 14, the second physically cross-linked thermoplastic polymer layer or chemically cross-linked rubber layer 16, and confined uncross-linked rubber layer 18 can each have a substantially uniform thickness of about 10 nm and about 10 mm. For example, the first physically cross-linked thermoplastic polymer layer or chemically cross-linked rubber layer 14, the second physically cross-linked thermoplastic polymer layer or chemically cross-linked rubber layer 16, and confined uncross-linked rubber layer 18 can each have a thickness of about 1 μm to about 10 mm, about 10 μm to about 10 mm, about 100 μm to about 10 mm, or about 1 mm to about 10 mm. or about 100 μm and about 1000 μm.

The ratio of the thicknesses of the first physically cross-linked thermoplastic polymer layer or chemically cross-linked rubber layer 14 and the second physically cross-linked thermoplastic polymer layer or chemically cross-linked rubber layer 16 to the confined uncross-linked rubber layer 18 can vary to vary or tune the impact energy absorption or damping and vibration dissipation of the multilayer material. For example, as the ratio of the thickness of the confined uncross-linked rubber layer 18 to the thicknesses of the first physically cross-linked thermoplastic polymer layer or chemically cross-linked rubber layer 14 and the second physically cross-linked thermoplastic polymer layer or chemically cross-linked rubber layer 16 increases, the impact energy absorption or damping and vibration dissipation of the multilayer material can be increased by for example at about 10%, at least about 15%, at least about 20%, at least about 25%, at least about 30%, at least about 35%, at least about 40%, at least about 45%, at least about 50% or more compared multilayer materials that include a first physically cross-linked thermoplastic polymer layer or chemically cross-linked rubber layer 14, a second physically cross-linked thermoplastic polymer layer or chemically cross-linked rubber layer 16, and a confined uncross-linked rubber layer 18 having similar thicknesses.

The thicknesses of the individual layers can also vary. For example, the ratio of thicknesses of the first physically cross-linked thermoplastic polymer layer or chemically cross-linked rubber layer 14, the confined uncross-linked rubber layer 18, and the second physically cross-linked thermoplastic polymer layer or chemically cross-linked rubber layer 16 can be about 1:1:1, about 1:2:1, about 1:3:1, about 1:4:1, about 1:5:1, about 1:6:1, about 1:7:1, about 1:8:1, about 1:9:1, or more including any range therebetween.

In some embodiments, one or more of the crosslinked layers can intentionally be varied in thickness from each other. For example, in a five layer system that includes three layers of physically cross-linked thermoplastic polymer or chemically cross-linked rubber, the middle layer of physically cross-linked thermoplastic polymer or chemically cross-linked rubber can differ in thickness from one or both of the surface layers of physically cross-linked thermoplastic polymer or chemically cross-linked rubber and can also differ in thickness from one or both of the two layers of uncross-linked rubber. In other embodiments, the multilayer material can include a gradient of layer thickness, with adjacent layer thicknesses progressively increasing or decreasing across the thickness of the multilayer material.

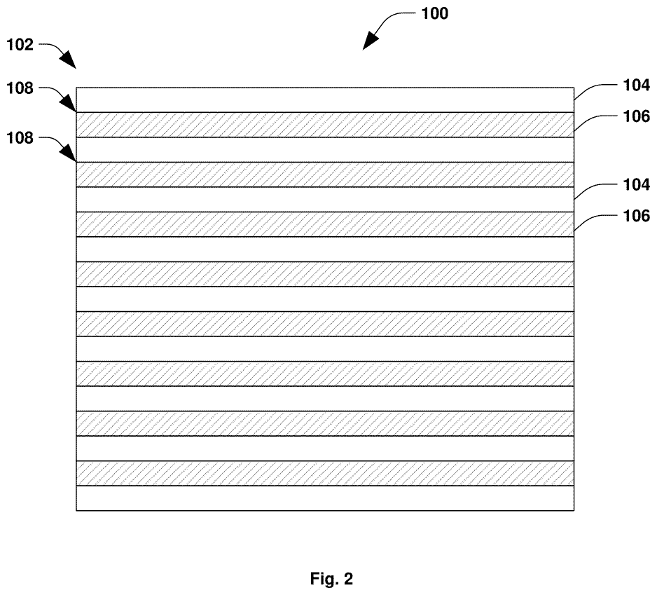

FIG. 2 illustrates a tunable multilayer material 100 for use in energy-damping and vibration dissipation in accordance with another embodiment. The tunable multilayer material 100 can include a stack 102 of alternating overlapping physically cross-linked thermoplastic polymer layers or chemically cross-linked rubber layers 104 and uncross-linked rubber layers 106. The physically cross-linked thermoplastic polymer layers or chemically cross-linked rubber layers 104 and uncross-linked rubber layers 106 can be substantially parallel and vertically stacked so that each physically cross-linked thermoplastic polymer layers or chemically cross-linked rubber layers 104 is adjacent to an uncross-linked rubber layers 106 and defines an interface 108 between each layer. Outer layers of the stack can include physically cross-linked thermoplastic polymer layers or chemically cross-linked rubber layers 104, so that underlying and overlying physically cross-linked polymer layers or chemically cross-linked rubber layers 104 of the stack 102 can sandwich or confine each uncross-linked rubber layer 106 to inhibit flow of each uncross-linked rubber layer 106 from the stack 10 or multilayer material 100 under load and/or stress.

Similar to FIG. 1, each physically cross-linked thermoplastic polymer layers or chemically cross-linked rubber layers 104 can include a physically cross-linked thermoplastic elastomer layers, such as thermoplastic styrenic elastomer (TPS), a thermoplastic polyolefin elastomer (TPO), a thermoplastic polyurethane (TPU), a thermoplastic copolyester (TPC), a thermoplastic polyamide (TPA), or silicone copolymer elastomer, or chemically cross-linked rubber, such as a partially vulcanized or cross-linked natural rubber (NR) or synthetic rubber.

Each uncross-linked rubber layer 106 can include an uncross-linked natural rubber (NR) or a fully unvulcanized synthetic rubber, such as fully unvulcanized isobutylene-isoprene rubber, a styrene butadiene rubber, an isoprene rubber, an acrylonitrile butadiene rubber, a butadiene rubber, a chloroprene rubber, an ethylene propylene rubber, an ethylene propylene diene rubber, polyisobutylene rubber, or a silicone rubber.

Each physically cross-linked thermoplastic polymer layer or chemically cross-linked rubber layer 104 can be formed from the same or different physically cross-linked thermoplastic elastomers or chemically cross-linked rubbers and have substantially the same, similar, or different loss tangents (tan δ) over the operating temperature, e.g., about −40° C. to about 50° C., of the multilayer material to vary or tune the impact energy absorption or damping and vibration dissipation of the multilayer material. Alternatively, different physically cross-linked thermoplastic polymer layers or chemically cross-linked rubber layers 104 can have substantially different tan Ss to exhibit damping characteristics in a range of frequencies from others.

The confined uncross-linked rubber layers 106 and the physically cross-linked thermoplastic polymer layer or chemically cross-linked rubber layer 104 can have substantially the same, similar, or different loss tangents (tan δ) over the operating temperature, e.g., about −40° C. to about 50° C., of the multilayer material to vary or tune the impact energy absorption or damping and vibration dissipation of the multilayer material. Alternatively, the confined uncross-linked rubber layer 18 and the first physically cross-linked thermoplastic polymer layer or chemically cross-linked rubber layer 14 and/or the second physically cross-linked thermoplastic polymer layer or chemically cross-linked rubber layer 16 can have substantially different tan δs to exhibit damping characteristics in a range of frequencies from others.

The physically cross-linked thermoplastic polymer layer or chemically cross-linked rubber layers 104, and confined uncross-linked rubber layers 106 can each have a substantially uniform thickness of about 10 nm and about 10 mm. For example, the physically cross-linked thermoplastic polymer layers or chemically cross-linked rubber layers 104 and confined uncross-linked rubber layers 106 can each have a thickness of about 1 μm to about 10 mm, about 10 μm to about 10 mm, about 100 μm to about 10 mm, or about 1 mm to about 10 mm. or about 100 μm and about 1000 μm.

The ratio of the thicknesses of the physically cross-linked thermoplastic polymer layers or chemically cross-linked rubber layers 104 to the confined uncross-linked rubber layers 106 can vary to vary or tune the impact energy absorption or damping and vibration dissipation of the multilayer material. For example, as the ratio of the thickness of the confined uncross-linked rubber layers 106 to the thicknesses of the physically cross-linked thermoplastic polymer layers or chemically cross-linked rubber layers 104 increases, the impact energy absorption or damping and vibration dissipation of the multilayer material can be increased by, for example, at about 10%, at least about 15%, at least about 20%, at least about 25%, at least about 30%, at least about 35%, at least about 40%, at least about 45%, at least about 50% or more compared multilayer materials that include physically cross-linked thermoplastic polymer layers or chemically cross-linked rubber layers 104 and a confined uncross-linked rubber layers 106 having similar thicknesses.

Advantageously, increasing the number of physically cross-linked thermoplastic polymer layers or chemically cross-linked rubber layers 104 and the confined uncross-linked rubber layers 106, and hence the number interfaces 108 between adjoining layers 104 and 106, can increase the impact energy absorption or damping and vibration dissipation of the multilayer material by, for example, at about 10%, at least about 15%, at least about 20%, at least about 25%, at least about 30%, at least about 35%, at least about 40%, at least about 45%, at least about 50% compared to multilayer materials 100 having similar thickness and weight ratios of physically cross-linked thermoplastic polymer layers or chemically cross-linked rubber layers 104 to confined uncross-linked rubber layers 106.

Optionally, the multilayer material 100 can include one or more additives (not shown), such as inorganic or organic fillers, that are provided in the physically cross-linked thermoplastic polymer layers or chemically cross-linked rubber layers 104, confined uncross-linked rubber layers 106, or interfaces 108 therebetween to modulate one or more mechanical, electrical, or chemical properties or barrier properties of the multilayer material 100. For example, the filler can be used for improving impermeability of targeted small molecules (gases/vapors), by creating a tortuous path through the material or attracting/trapping small molecules.

In some embodiments, the filler can include a thermally conductive filler that exhibits a damping effect for impact energy absorption and vibration dissipation by dissipating heat in the multilayer material. Examples of thermally conductive fillers can include particles of metal oxides, such as aluminum oxide (Al₂O₃), calcium oxide (CaO₂), magnesium oxide (MgO), zinc oxide (ZnO), titanium oxide (TiO₂), silicon oxide (SiO₂), iron oxide (Fe₂O₃), nickel oxide (NiO), and copper oxide (CuO), metal nitrides such as boron nitride (BN), aluminum nitride (AlN), and silicon nitride (Si₃N₄), metal carbides, such as boron carbide (B₄C), aluminum carbide (Al₄C₃), silicon carbide (SiC), and titanium carbide (TiC), and metal hydroxides, such as aluminum hydroxide [Al(OH)₃], magnesium hydroxide [Mg(OH)₂], sodium hydroxide (NaOH), calcium hydroxide [Ca(OH)₂], and zinc hydroxide [Zn(OH)₂]. One kind or two or more kinds can be selected from among particles of the metal oxide, metal nitride, metal carbide, and metal hydroxide, and are used as the thermally conductive filler. Among others, particles of magnesium oxide, aluminum oxide, silicon oxide, aluminum nitride, silicon nitride, boron nitride, silicon carbide, and the like are preferable as thermally conductive fillers since they are high in thermal conductivity.

Other fillers can include other particles or fibers, such as carbon black, graphene, carbon nanotubes, carbon nanowires, fullerenes (C60), talc, mica, kaolin, calcium carbonate, magnesium carbonate, metal-organic framework (MOF) filler, glass microspheres, glass nanospheres, and their modifications.

Metallic powders can be used as inorganic fillers in the multilayer material. For example, metal powders such as aluminum, copper or special steel, molybdenum disulfide, iron oxide, e.g., black iron oxide, antimony-doped titanium dioxide and nickel doped titanium dioxide. Metal alloy particulates can also be used.

Additives, such as pigments, ultraviolet light absorbers, ultraviolet stabilizers, antioxidants, fire retardant agents, thermally or electrically conductive agents, post curing agents, and the like can be blended into or provided in the physically cross-linked thermoplastic polymer layer or chemically cross-linked rubber layer 104, confined uncross-linked rubber layers 106, or interfaces 108 to modify the properties of the multilayer materials. These additives can also include, for example, one or more inhibitors, defoamers, colorants, luminescents, buffer agents, anti-blocking agents, wetting agents, matting agents, antistatic agents, acid scavengers, processing aids, extrusion aids, and others. Ultraviolet light absorbers include hydroxyphenyl benzotriazoles, hydrobenzophenones, and hindered amines. Antioxidants include, for example, hindered phenols, amines, and sulfur and phosphorus hydroxide decomposers, such as Irganox 1520L. The fillers, pigments, plasticizers, flame retardants, UV stabilizers, and the like are optional in many embodiments and can be used at concentrations of, for example, about 0 to about 30% or more, such as up to about 40% in particular embodiments. In certain embodiments, the total amount of fillers (inorganic and/or organic), pigments, plasticizers, flame retardants, UV stabilizers, and combinations thereof is from about 0.1% to about 30%, and more particularly from about 1% to about 20%.

Optionally, the multilayer material can further include at least one tie layer or adhesive layer (not shown). The adhesive layer can be randomly distributed in the multilayer material or alternated with the physically cross-linked thermoplastic polymer layers or chemically cross-linked rubber layers 104 and the confined uncross-linked rubber layers 106 together to bond or stick the layers together. The adhesive layer can also be provided on one or both exterior surfaces of the multilayer material to adhere the multilayer material to a desired substrate.

Examples of the adhesive suitable for the adhesive layer can include rubber-base adhesive, acrylic adhesive, silicone-based adhesive, and the like.

In some embodiments, the rubber-base adhesive can include adhesives of natural rubber base, isoprene rubber base, styrene-butadiene rubber base, regenerated rubber base and polyisobutylene rubber base, as well as rubber-containing block copolymers, such as styrene-isoprene-styrene, styrene-butadiene-styrene, and the like.

In some embodiments, the acrylic adhesive can include polymers or copolymers containing as a base an acrylic or methacrylic acid derivative, such as acrylic ester, methacrylic ester, acrylamide, acrylonitrile, or the like. In this regard, a copolymer of an acrylic or methacrylic ester and a monomer, such as acrylic acid, methacrylic acid, acrylamide, methacrylamide, vinyl acetate, styrene, or the like, is especially preferred.

In this instance, considering the properties of the adhesive under low temperature conditions (e.g., in a case where the multilayer material is wrapped around a structure of low temperature, like a coolant pipe of an air conditioner), the adhesive is preferred to have a relatively low glass transition temperature (Tg).

In some embodiments, the silicone based adhesive can include dimethylsiloxane-and diphenylsiloxane-based adhesives.

The above-exemplified adhesives may be a cross-linked type or a non-cross-linked type. In case of the cross-linked type, crosslinking can be effected by the use of a substance containing a group with active hydrogen like hydroxyl group, amino group or carboxyl group, epoxy group or methylol group, isocyanate, chelate resin, melamine resin, urea resin, peroxide, metal oxide, acid, acid anhydride or the like, or alternatively by ultraviolet irradiation, depending upon the nature of the functional group.

If necessary, the adhesive layer may include a tackifier, a plasticizer, a filler, an anti-aging agent, or other additives. Examples of useful tackifiers include rosin and its derivatives, polyterpene, terpene phenol resin, coumarone-indene resin, and petroleum resin. Examples of useful plasticizers include liquid polybutene, mineral oil, lanolin, liquid polyisoprene, and liquid polyacrylate. Examples of fillers include zinc white, calcium carbonate, aluminum hydroxide, diatomaceous earth, clay, carbon powder, and various inorganic and organic fillers. Examples of useful anti-aging agents include metal dithiocarbamate.

In some embodiments, the multilayer material 100 can include an outer surface layer or an external constraining layer. An external constraining layer is a constraining layer that can provide an outer surface of the multilayer material that is open to the external environment and opposite a substrate to which the multilayer material can be applied. The constraining layer can independently comprise one or more stiffening materials that serve to provide a stiffened structure to each constraining layer, wherein each of the constraining layers can have a similar or different composition. The stiffening materials can include one or more polymeric materials. Nonlimiting examples of polymeric materials include polyvinyl chloride (PVC), polyolefins such as polyethylene (PE) and/or polypropylene (PP), polyethylene terephthalate (PET), polycarbonate (PC), polystyrene (PS), and combinations of these and other materials.

In some embodiments, at least one constraining layer comprises a metal. The metal of at least one constraining layer may comprise at least one metal of aluminum, steel, magnesium, bronze, copper, brass, titanium, iron, beryllium, molybdenum, tungsten, or osmium. In some embodiments, the metal is a metal powder. In other embodiments, the metal is a metal foil. In yet other embodiments, at least one constraining layer comprises both a metal powder and a metal foil. The metals may be stiffening materials and can include one or more metals or metal alloys. Nonlimiting examples of metals include aluminum, steel, magnesium, bronze, copper, brass, titanium, iron, beryllium, molybdenum, tungsten, or osmium. In some embodiments, the internal constraining layer and the external constraining layer are each independently a metal foil, e.g., aluminum foil. Metal foils may include, but are not limited to, at least one metal of aluminum, steel, magnesium, bronze, copper, brass, titanium, iron, beryllium, molybdenum, tungsten, or osmium.

The stiffening materials can include one or more natural or manufactured woods. The stiffening materials can include one or more fibers. Non-limiting examples of fibers include hemp fibers, flax fibers, glass fibers, aramid fibers, and carbon fibers. The stiffening materials can include one or more carbon-based materials, including carbon nanotubes, graphene, diamond, carbide, or combinations thereof. Composite materials and combinations of these materials could also be used.

The multilayer material can be formed by confining at least one uncross-linked rubber layer between at least two physically cross-linked thermoplastic polymer layers or cross-linked rubber layers to form a multilayer material. FIG. 3 is a flow diagram illustrating a method 200 of confining the at least one uncross-linked rubber layer between at least two physically cross-linked thermoplastic polymer layers or cross-linked rubber layers. In the method, 200, at step 210, at least one uncross-linked rubber film and at least two physically cross-linked thermoplastic polymer films or cross-linked rubber films are formed by at least one of solution-based methods, melt processing, vapor deposition methods, emulsion or dispersion-based methods, or additive methods.

In some embodiments, the at least one uncross-linked rubber film and the at least two physically cross-linked thermoplastic polymer films can be melt-processed using any solvent-free melt processing technique to form uncross-linked rubber films and physically cross-linked thermoplastic polymer films. Such processing techniques can include, for example, hot-pressing (compression molding), extrusion, or injection molding.

For example, pellets, slabs, or powder of the uncross-linked rubber or physically cross-linked thermoplastic polymer, such as a physically cross-linked thermoplastic elastomer, and optionally one or more fillers, can be melt-processed by hot-pressing pellets, slabs, or powder. During hot-pressing, pellets, slabs, or powder of the uncross-linked rubber or physically cross-linked thermoplastic polymer and optionally one or more fillers can be placed in a mold between two platens heated to a temperature above the Tg of the respective uncross-linked rubber or physically cross-linked thermoplastic polymer and pressed using a hydraulic or mechanical press to provide an uncross-linked rubber films or sheet or physically cross-linked thermoplastic polymer films or sheets having substantially uniform thicknesses.

Alternatively, pellets or powder of the uncross-linked rubber or physically cross-linked thermoplastic polymer and optionally one or more fillers can be fed into a solid-state extrusion system (e.g., extruder), with a heated barrel at a temperature above the Tm of the pellets or powder of the uncross-linked rubber or physically cross-linked thermoplastic polymer, and passed through an extrusion die to produce thin film or sheets of the uncross-linked rubber or physically cross-linked thermoplastic polymer.

After formation of the films of the uncross-linked rubber and the physically cross-linked thermoplastic polymer or chemically cross-linked rubber, at step 220 at least one surface of the films can be optionally dusted with one or more fillers, stacked with an optional adhesive layer, such that at least one uncross-linked rubber film is sandwiched between two physically cross-linked thermoplastic polymer films or chemically cross-linked rubber films.

At step 230, the stacked films can then be consolidated using heat and/or pressure, e.g., using autoclave consolidation techniques, or using adhesive or adhesive layers that bind the stacked individual multilayer polymer films to confine at least one uncross-linked rubber film between at least two physically cross-linked thermoplastic polymer films or cross-linked rubber films to form a multilayer material. The multilayer material so formed can include at least two physically cross-linked thermoplastic polymer layers or chemically cross-linked rubber layers that inhibit flow of at least one confined uncross-linked rubber layer from the multilayer material under load and/or stress.

In other embodiments, the multilayer material can formed by forced assembly co-extrusion of uncross-linked rubber films and physically cross-linked thermoplastic polymers films with optional fillers in which uncrossslinked rubber films and physically cross-linked thermoplastic polymers films are layered and then multiplied several times or by traditional multilayer coextrusion processing where layering is accomplished simultaneously in a single multilayered feed block.

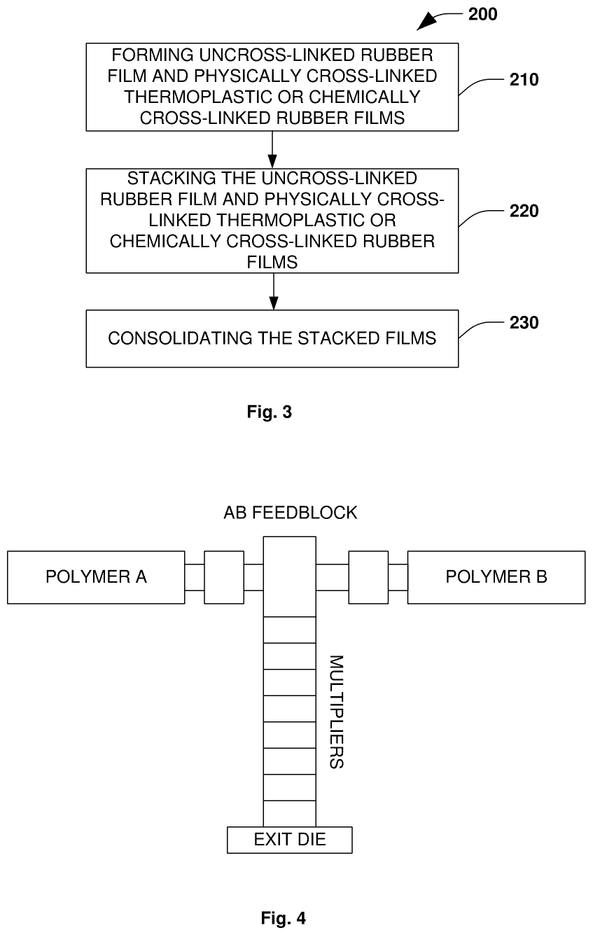

For example, a typical two component (AB) multilayer coextrusion apparatus is illustrated in FIG. 4. The two component (AB) coextrusion apparatus can consist of two single screw extruders each connected by a melt pump to a coextrusion feedblock. The feedblock for this two component system combines a physically cross-linked thermoplastic polymer (a) and uncrossslinked rubber (b) in an (AB) layer configuration. The melt pumps control the two melt streams that are combined in the feedblock as two parallel layers. By adjusting the melt pump speed, the relative layer thickness, that is, the ratio of A to B, can be varied. From the feedblock, the melt goes through a series of multiplying elements. A multiplying element first slices the AB structure vertically, and subsequently spreads the melt horizontally. The flowing streams recombine, doubling the number of layers. An assembly of n multiplier elements produces an extrudate with the layer sequence (AB)ₓ where x is equal to (2)² and n is the number of multiplying elements. It is understood by those skilled in the art that the number of extruders used to fabricate the structure equals the number of components or polymer materials. Thus, a three-component multilayer (ABC . . . ) , requires three extruders.

The multilayer material can include at least 4, 6, 8, 10, 12, 14, 16, 18, 20, 30, 40, 50, 60, 70, 80, 90, 100 or more layers, including any number of layers within that range. For example, the multilayer structure can have from about 30 to about 10000 layers. The multilayer material can be in the form of a film or sheet. By altering the relative flow rates or the number of layers, while keeping the film or sheet thickness constant, the individual layer thickness can be controlled.

In some embodiments, the stacked films or multilayer material can be heat-sealed, patterned, compressed, or stamped to enhance strength, reduce creep, and/or provide energy dissipation paths in the multilayer material. For example, grid-like or checkerboard-like patterns formed by, for example, imprint molding, hot pressing, roller embossing, or calendaring to press and join ribs of thermoplastic elastomer together, creating pockets of the uncross-linked rubber materials. Optionally, the stacked films or multilayer materials can be imprinted with heated rods that form holes in the multilayer material to achieve sealing of the uncross-linked rubber materials. Such sealing can be depth controlled, from two layers deep to puncturing through all layers, and can vary across the surface of the film/part.

In other embodiments, where the multilayer material does not include chemically cross-linked polymer layers, such as chemically cross-linked rubber layers, the multilayer can be formed into a predetermined shape, by heating the multilayer material to a temperature below the melting temperature of any of the polymers within the multilayer material. The heated multilayer material can then be thermoformed in a die or mold forming the multilayer material into the predetermined shape that is maintained when the heated multilayer material cools.

Optionally, following formation of the multilayer material, at least a portion of the uncross-linked rubber film and/or the physically cross-linked thermoplastic polymer films can be cross-linked. For example, at least a portion of the uncross-linked rubber film and/or the physically cross-linked thermoplastic polymer films can be cross-linked after confining the uncross-linked rubber layer or after thermoforming. The crosslinking can be achieved by activating reactive additives or exposure to, for example, high-energy radiation including electron beams or gamma rays.

The energy-damping and vibration dissipation multilayer material so formed can potentially be used in any application in which it is desired to dampen impact energy or dissipate vibration. Such energy-damping and vibration dissipation multilayer material can have an extremely wide range of applications, encompassing for instance electric appliances, such as air conditioners, refrigerators, washing machines, ventilating fans, and the like, gas equipments, such as water heaters, bath boilers and the like, office machines such as copiers, printers, facsimile machines, audio devices and the like, various industrial machines and apparatus such as compressors, hoppers, lathes, milling machines, electric power tools, various motors, precision instruments and the like, engine rooms or environs, cabins or passenger rooms, chassis, bodies of automobiles, vehicles, aircrafts, construction machines or the like, building and utility materials, such as floors, ceilings, exterior doors, window frames, roofs, shutters, interior doors, sound insulation walls, vibration-proof walls, gas pipes, running water pipes and the like, office furniture such as steel desks, chairs, bookcases and the like, and daily utensils and sport equipment, such as helmets, soldier protective gear, and the like where it is desirable to dampen impact energy or dissipate vibration.

The energy-damping and vibration dissipation multilayer material can be used in the form of large-, medium-or small-size sheets, labels, elongated tapes or strips or in any other arbitrary forms. The energy-damping and vibration dissipation multilayer material can easily adapt itself to a curved surface by flexure, and is especially suitable for adhesion to a curved surface of a pipe, rod, ball, helmet, prosthetic, or the like, and particularly suitable for adhesion to an object or structure with a three-dimensional curved surface.

The invention is further illustrated by the following examples, which is not intended to limit the scope of the claims.

### EXAMPLES

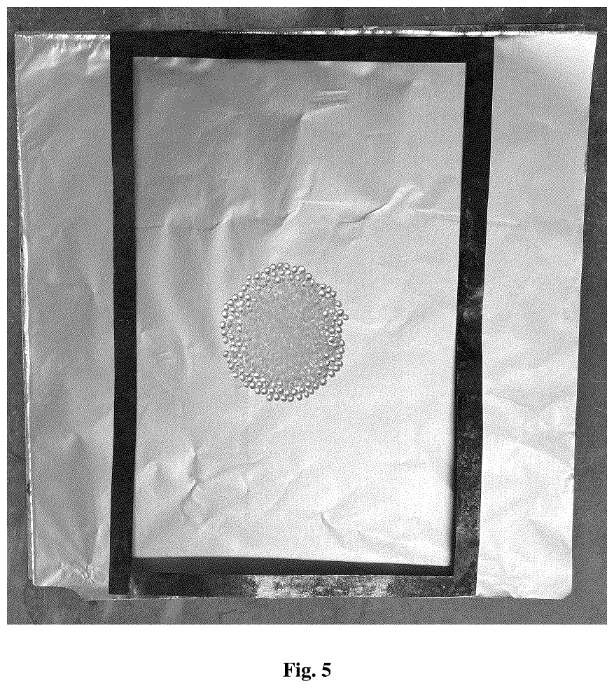

FIG. 5 illustrates an image showing preparation of a film via melt-pressing. Thermoplastic elastomer (TPE) pellets of SIBS B are placed in a die sandwiched and between nonstick foil-lined metal plates.

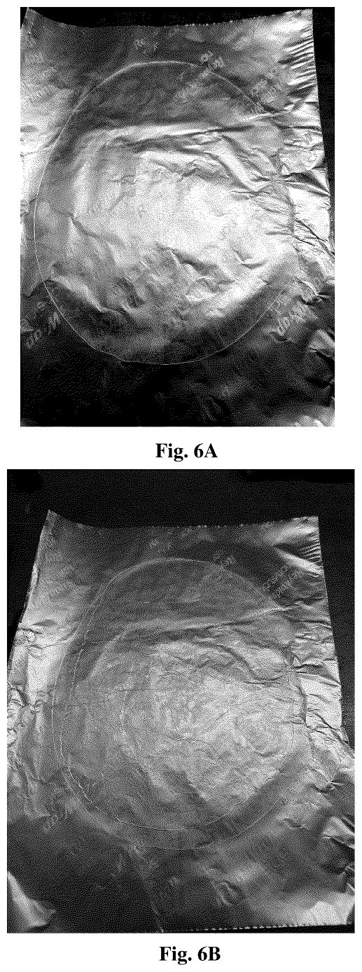

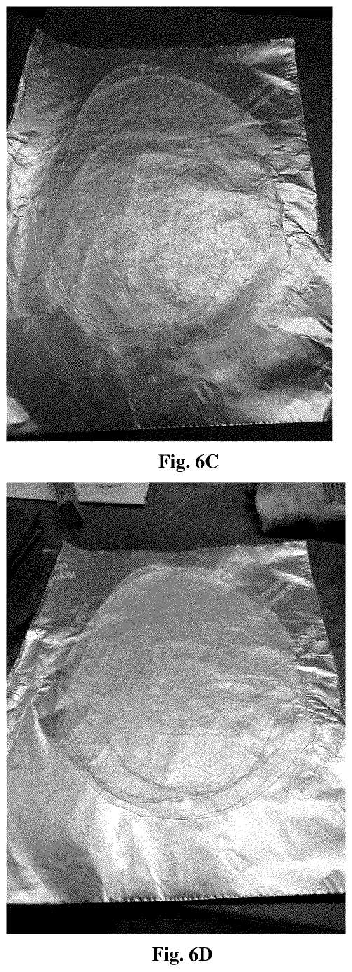

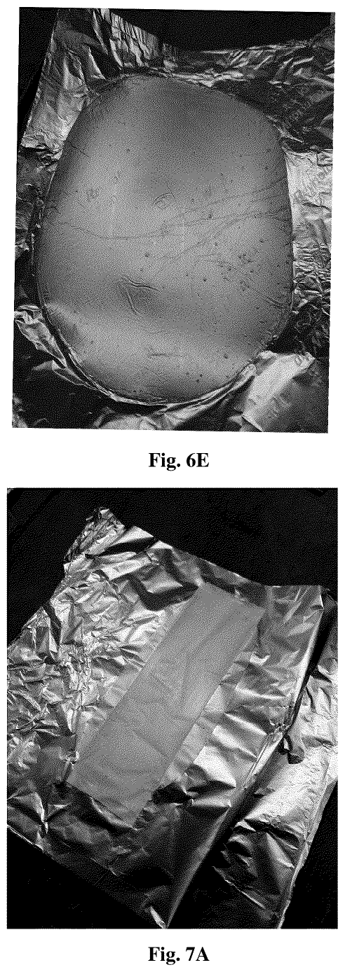

FIG. 6(A-E) illustrate individual films formed from the raw material then stacked prior to melt-pressing. Bottom layer of SIBS B, adding 3 layers of butyl, then finally a top SIBS B layer. The bottom image is the post-pressed film, which is now fused into a three-layer material with surface layer of SIBS and a core of butyl.

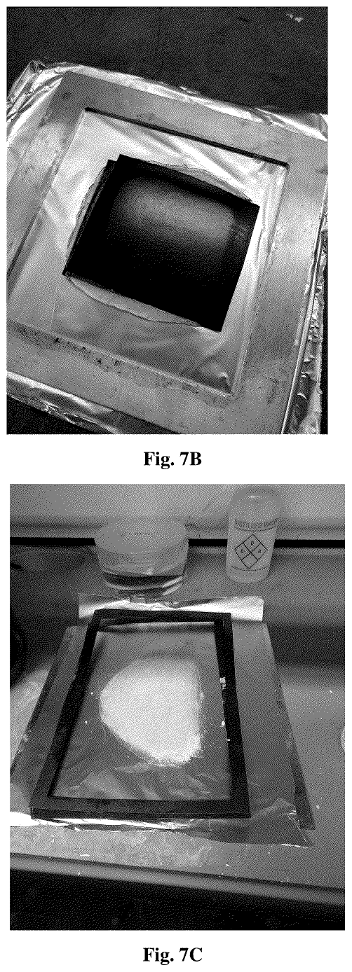

FIG. 7(A-C) illustrate (A) a melt-pressed trilayer film of a previously coextruded HDPE (a thermoplastic) and butyl; (B) a melt-pressed trilayer film of SBR (chemically crosslinked) and butyl; and (C) an SIBS B and butyl trilayer film, which has had an internal surface dusted with a metal-organic framework (MOF) filler, ready to be melt-pressed.

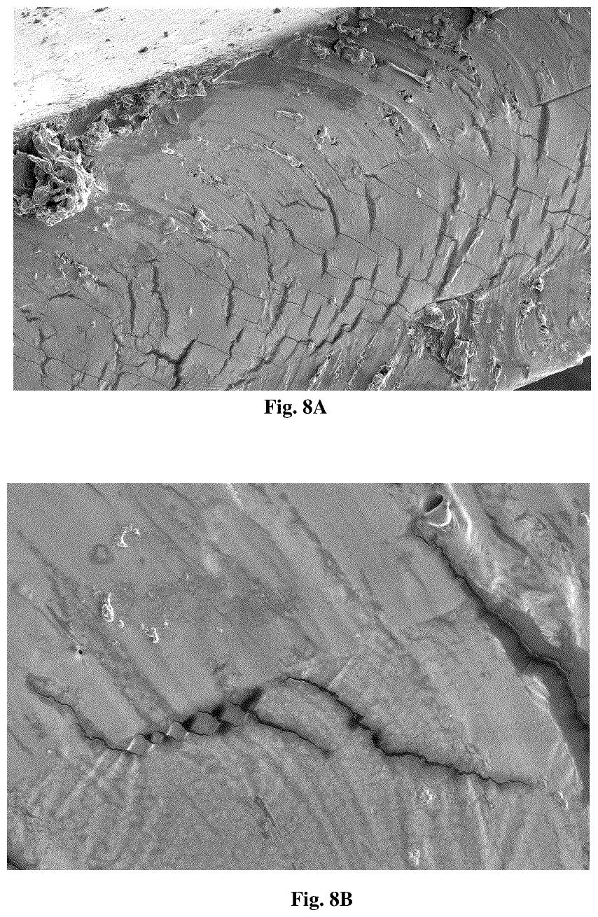

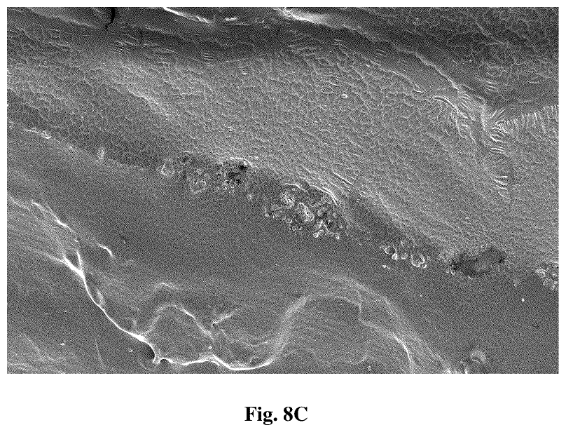

FIG. 8(A-C) illustrate: (A) 200× scanning electron microscope (SEM) image of a cryofracture surface of a SIBS A: Butyl Trilayer; (B) a 2000× scanning electron microsope (SEM) image of the sample of (A) demonstrating the neat interface between the materials; and (C) a 2000× scanning electron microsope (SEM) image of the interface of a trilayer sample that has been intentionally dusted with a metal-organic framework (MOF). For FIGS. 8A-B, the thickness of the middle layer (butyl) is about 250 μm with clearly identifiable interfaces between the materials. For FIG. 8C, sub-5 μm crystals can be seen aggregated at the interface.

FIG. 9 illustrates plots showing the averaged tensile properties of two different grades of the thermoplastic elastomer SIBS and an unvulcanized butyl tested using ASTM D412.

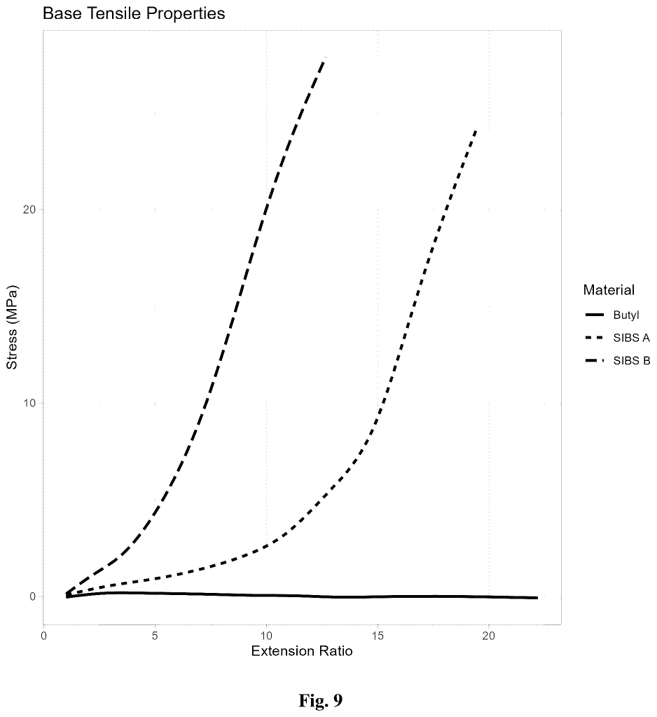

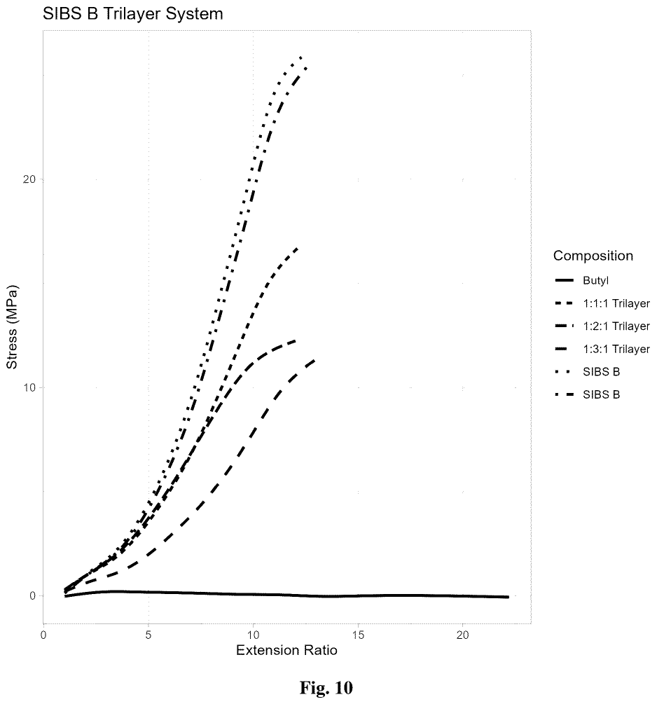

FIG. 10 illustrates plots showing the averaged tensile properties of the thermoplastic elastomer SIBS B and butyl trilayer system tested using ASTM D412. As the amount of butyl in the core increases from about 1× to 3× or about 33% to 60% respectively, the max stress decreases while the max strain is held constant by the SIBS B surface layers.

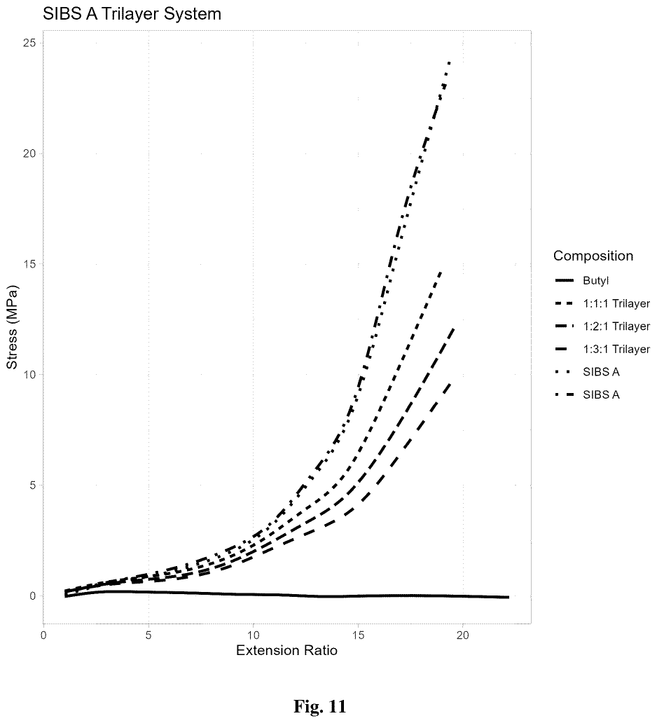

FIG. 11 illustrates plots showing the averaged tensile properties of the thermoplastic elastomer SIBS A and butyl trilayer system tested using ASTM D412. As the amount of butyl in the core increases from about 1× to 3× or about 33% to 60% respectively, the max stress decreases while the max strain is held constant by the SIBS A surface layers.

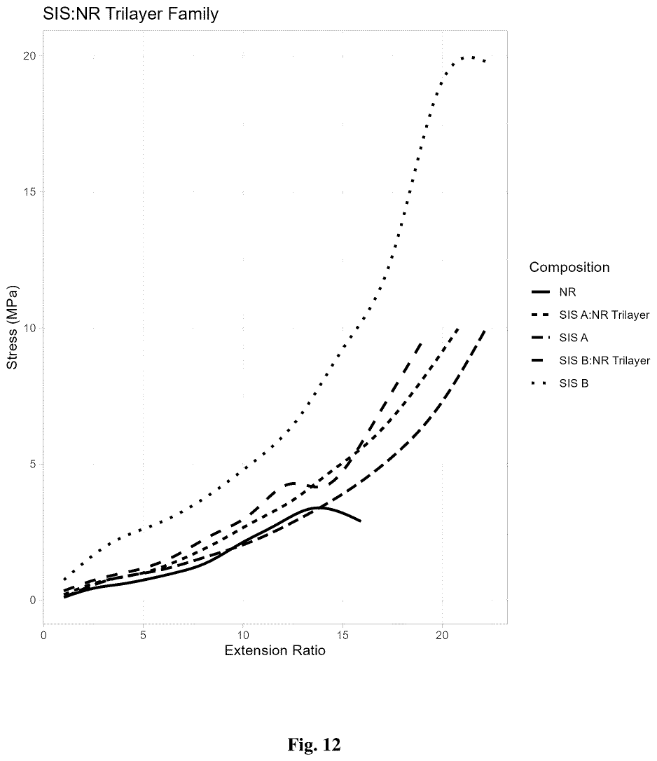

FIG. 12 illustrates plots showing the averaged tensile properties of the thermoplastic elastomer SIS and NR trilayer family tested using ASTM D412. For both trilayers, each using NR and a different grade of SIS, the stress response is shown to between that of the films' individually tested components.

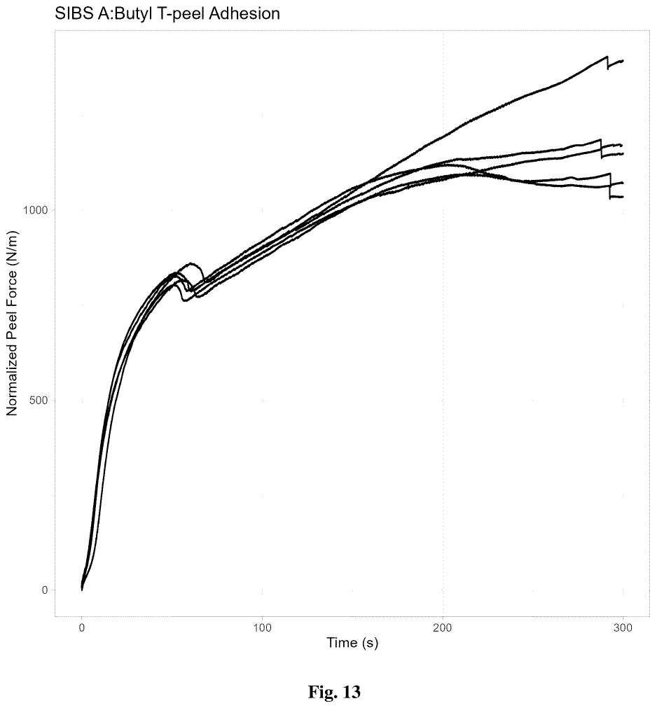

FIG. 13 illustrates plots showing measured adhesion data between SIBS A and butyl. Trilayer samples were prepared for this T-peel testing and a moderate peel force was observed.

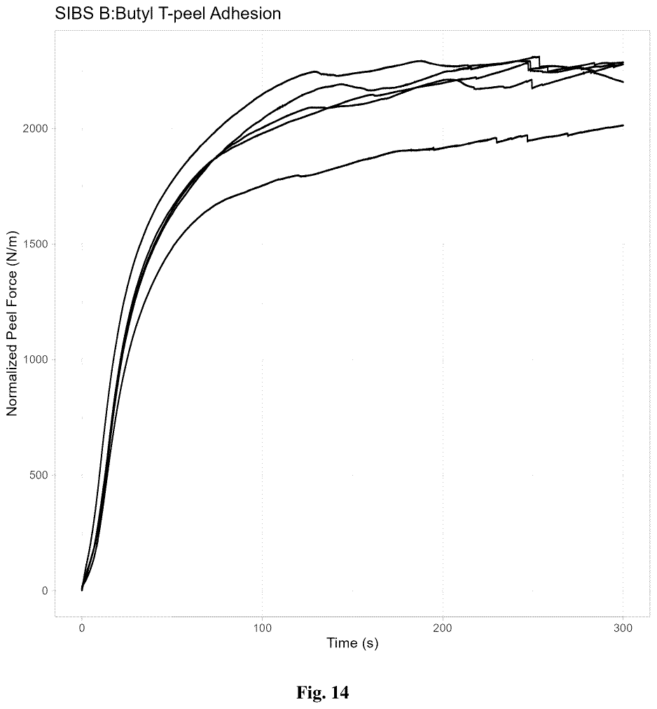

FIG. 14 illustrates plots showing measured adhesion data between SIBS B and butyl. Trilayer samples were prepared for this T-peel testing and a large peel force was observed.

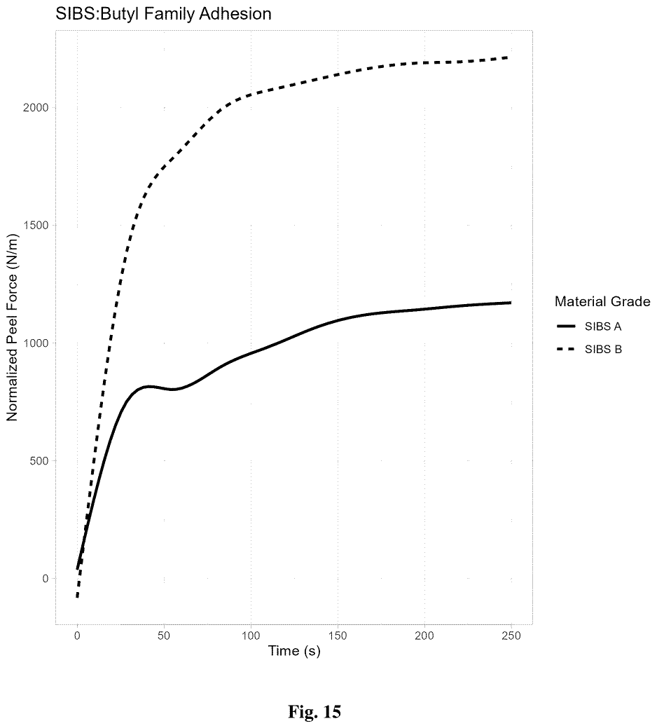

FIG. 15 illustrates averaged curves of the data found in FIG. 14 and FIG. 15. Both materials show a strong adhesive force, which is more than high enough for material use, however the adhesion with the SIBS B grade is nearly twice as strong.

For samples shown FIGS. 13-15 higher adhesion is generally better

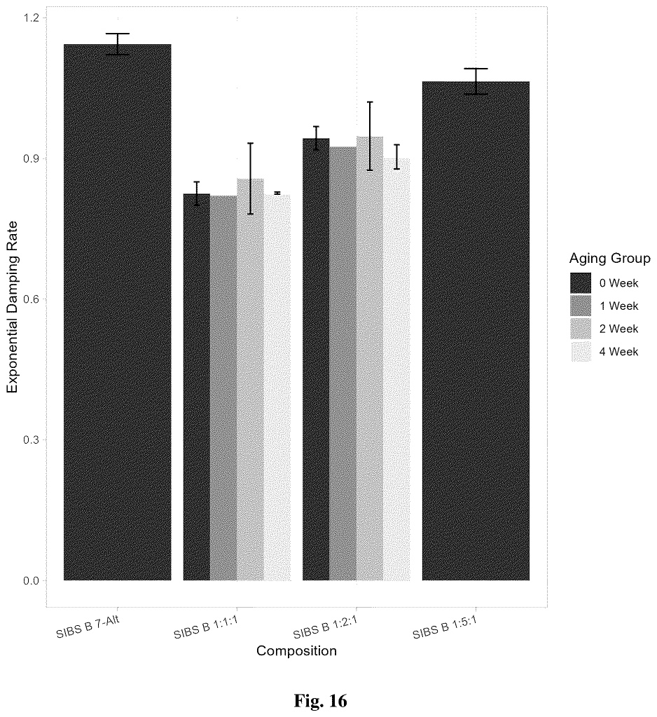

FIG. 16 illustrates plots showing exponential damping rate of several film compositions using SIBS B and butyl across a month of aging gathered using a custom ball drop tower. As can be seen, the aging has little to no impact on the material performance, performance increases with increasing butyl thickness from about 1× to 5× or about 33% to 71% respectively, and performance increases with increasing number of interfaces. The latter is seen when comparing the 7-Alt film, which has six interfaces and about 43% butyl, to the two-interface 1:5:1 film of comparable thickness, and the about 33% to 50% butyl films 1:1:1 and 1:2:1, respectively.

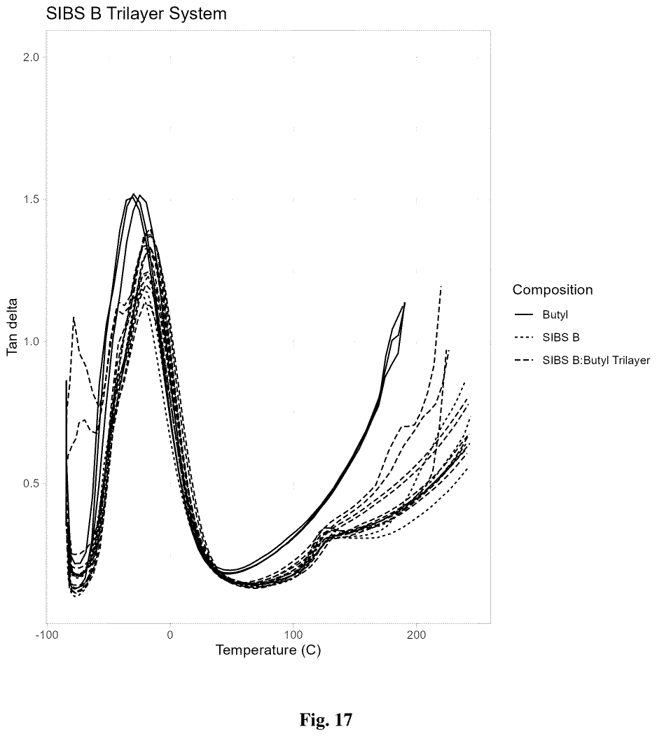

FIG. 17 illustrates plots showing dynamic mechanical analysis of the thermoplastic elastomer SIBS B and butyl trilayer system. Tan δ with respect to temperature was recorded across the base films and several trilayer compositions. Significant shifting of the broad butyl peak towards room temperature is observed with the trilayers.

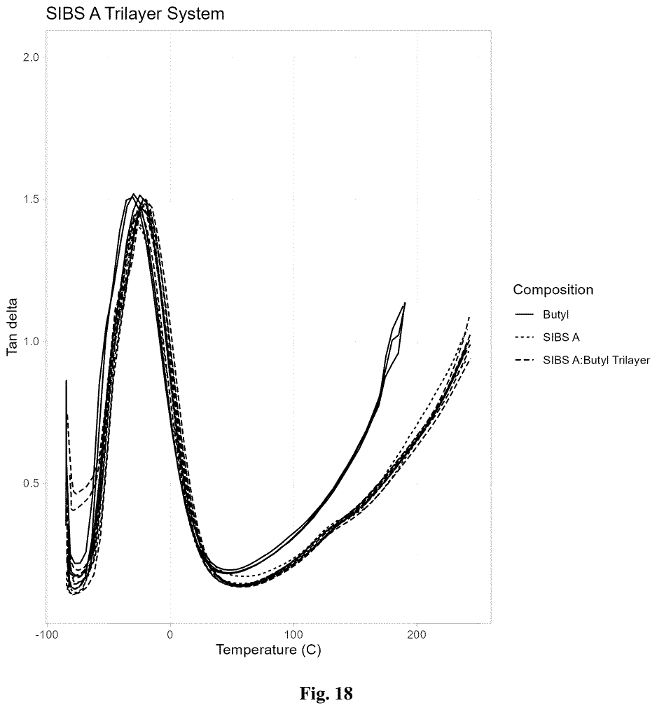

FIG. 18 illustrates plots showing the dynamic mechanical analysis of the thermoplastic elastomer SIBS A and butyl trilayer system. Tan δ with respect to temperature was recorded across the base films and several trilayer compositions. Shifting of the broad butyl peak towards room temperature is observed with the trilayers.

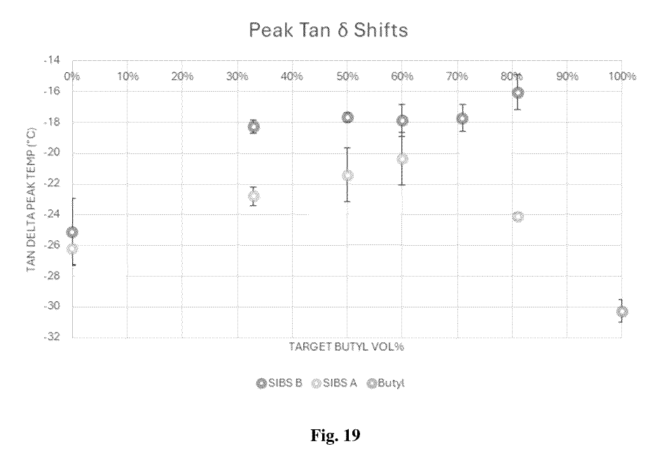

FIG. 19 illustrates plots extracted tan δ peak temperature values from FIG. 17 and FIG. 18 plotted against the volume percentage of the unvulcanized butyl. The trilayer film peaks move toward room temperature outperforming the sum of their components, with SIBS B showing larger gains than SIBS A. Optimal compositions are shown to be around 60% to 80% butyl depending on the system.

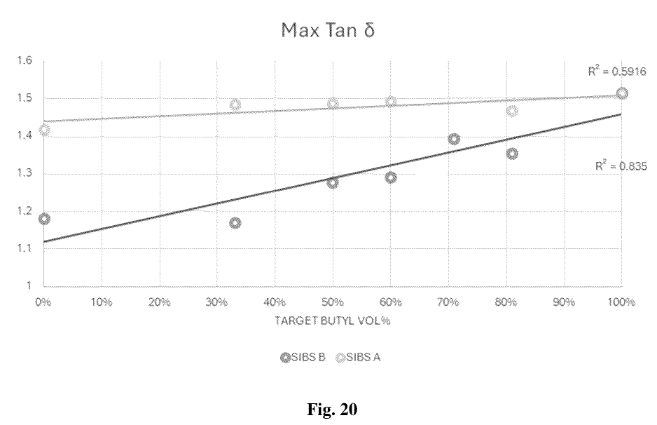

FIG. 20 illustrates plots showing extracted peak tan δ values from FIG. 17 and FIG. 18 plotted against the volume percentage of the unvulcanized butyl. Although more pronounced in SIBS B, a linear response is seen for both systems with respect to increasing butyl volume percentage; indicating the peak tan δ value is simply proportional to the amount of butyl in the system.

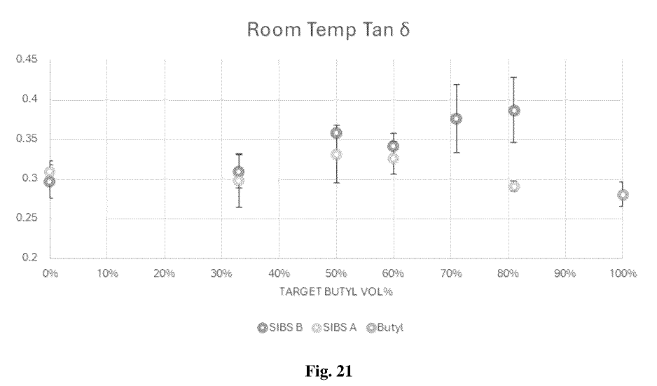

FIG. 21 illustrates plots showing extracted tan δ values at room temperature from FIG. 17 and FIG. 18 plotted against the volume percentage of the unvulcanized butyl. A general trend of increased tan δ is seen with increasing butyl precent of the trilayer films again outperforming the sum of their components. SIBS B systems have consistently higher tan δ, and the biggest gains are seen in both systems above about 50% butyl.

For FIGS. 17-21, higher values of tan delta are better for damping. Especially at testing conditions such as room temperature.

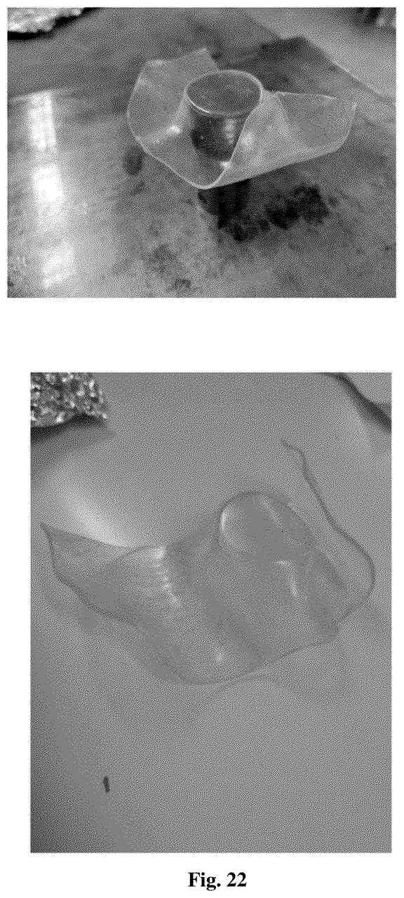

FIG. 22 illustrates an image of a trilayer film of thermoplastic elastomer SIBS B, which has been heated up to about the Tg of the styrene blocks and has been subsequently drawn over a small steel cylinder. The thermoformed film was able to retain its new shape upon cooling.

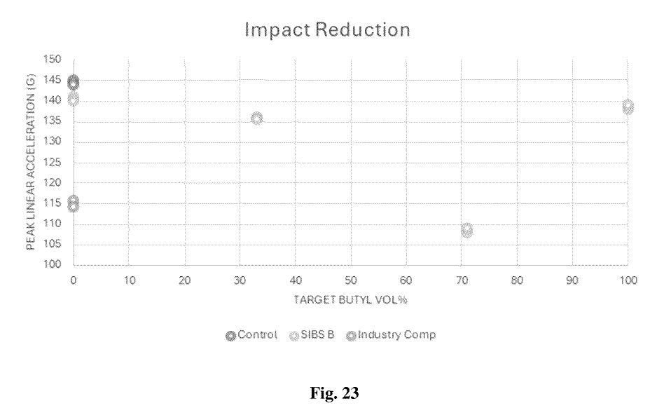

FIG. 23 illustrates plots showing peak linear acceleration data as recorded by a higher-energy impact approximating a personal fall or collision. Lower values are better and as can be seen SIBS B shows significant gains of about 33% reduction at about 70% butyl and outperforms an industry comparison of similar thickness which shows only about 25% reduction.

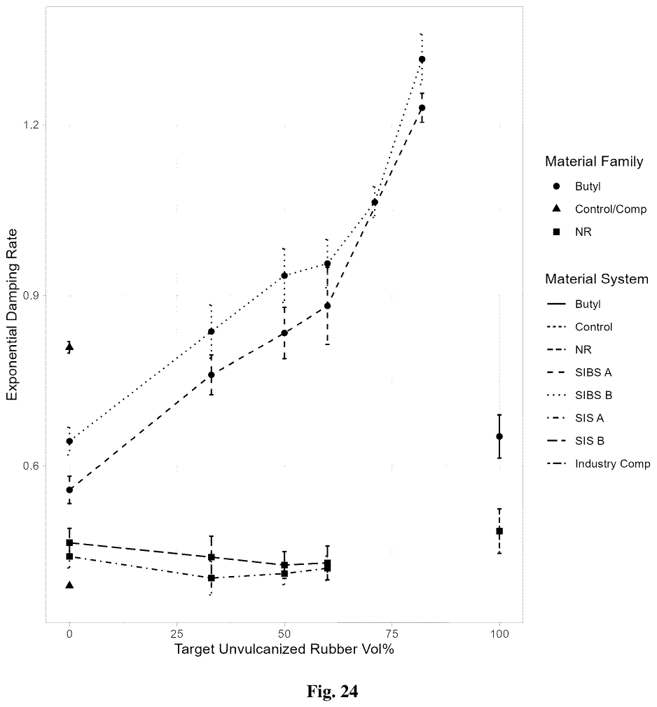

FIG. 24 illustrates plots showing the compiled exponential damping rate data of two material families (SIBS:Butyl and SIS:NR) as gathered using a custom ball drop tower. The higher the value the better the material dampens, and as can be seen the SIBS:Butyl material family out-performs the SIS:NR material family at all loadings as well as the industry comparison at moderate to high butyl volume percentage. This family in particular shows demonstrates high tunability with respect to material grade and butyl thickness and shows with gains greater than the sum of its individual components observed.

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

1. A multilayer material comprising a plurality of energy-damping and/or vibration dissipation overlapping polymer layers, wherein at least thermoplastic polymer layers, which are optionally physically crosslinked, or chemically cross-linked rubber layers confine at least one uncross-linked rubber layer to inhibit flow of the at least one uncross-linked rubber layer from the multilayer material under load and/or stress.

2. The multilayer material of claim 1, wherein the plurality of energy-damping and/or vibration dissipation overlapping polymer layers include at least two physically cross-linked thermoplastic elastomer layers or chemically cross-linked rubber layers that confine the at least one uncross-linked rubber layer.

3. The multilayer material of claim 2, wherein the physically cross-linked thermoplastic elastomer layers include at least one of a styrenic block copolymer elastomer (TPS), a thermoplastic polyolefin elastomer (TPO), a thermoplastic polyurethane (TPU), a thermoplastic copolyester (TPC), a thermoplastic polyamide (TPA), or silicone copolymer elastomer.

4. The multilayer material of claim 2, wherein the at least one uncross-linked rubber layer includes at least one of an uncross-linked natural rubber (NR) or a fully unvulcanized synthetic rubber.

5. The multilayer material of claim 1, comprising a stack of alternating overlapping physically cross-linked thermoplastic polymer layers or chemically cross-linked rubber layers and uncross-linked rubber layers, wherein underlying and overlying physically cross-linked polymer layers or chemically cross-linked rubber layers sandwich or confine at least one uncross-linked rubber layer to inhibit flow of the at least one uncross-linked rubber layer from the multilayer material under load and/or stress.

6. The multilayer material of claim 1, wherein adjoining physically cross-linked thermoplastic polymer layers or chemically cross-linked rubber layers and uncross-linked rubber layers define generally planar interfaces therebetween.

7. The multilayer material of claim 1, further comprising at least one tie layers or surface layers for additional functionalities.

8. The multilayer material of claim 1, wherein the interfaces and/or layers further include at least one organic/inorganic filler.

9. The multilayer material of claim 1, being thermoformable into various shapes.

10. A method of forming an energy-damping and/or vibration dissipation material, the method comprising:
confining at least one uncross-linked rubber film between at least two physically cross-linked thermoplastic polymer films or cross-linked rubber films to form a multilayer material, wherein at least two physically cross-linked thermoplastic polymer layers or chemically cross-linked rubber layers inhibit flow of at least one confined uncross-linked rubber layer from the multilayer material under load and/or stress.

11. The method of claim 10, wherein the at least one uncross-linked rubber film and the least two physically cross-linked thermoplastic polymer films or cross-linked rubber films are formed by at least one of solution-based methods, melt processing, vapor deposition methods, emulsion or dispersion-based methods, or additive methods.

12. The method of claim 10, wherein the at least one uncross-linked rubber film is confined between the at least two physically cross-linked thermoplastic polymer films or chemically cross-linked rubber films by stacking the at least one uncross-linked rubber film between the at least two physically cross-linked thermoplastic polymer films or cross-linked rubber films and consolidating the stacked films under pressure to obtain a flat multilayer material.

13. The method of claim 10, wherein the at least one uncross-linked rubber film is confined between the at least two physically cross-linked thermoplastic polymer films by extruding the at least one uncross-linked rubber film and the at least two physically cross-linked thermoplastic polymer films and consolidating the stacked films or coextruding the at least one uncross-linked rubber film and the physically cross-linked thermoplastic polymer film and optionally multiplying the coextruded films to obtain a flat multilayer material.

14. The method of claim 12, wherein the stacked films are heat-sealed, patterned, compressed, or stamped to enhance strength, reduce creep, and/or provide energy dissipation paths in the multilayer material.

15. The method of claim 10, further comprising shaping the multilayer material by thermoforming the multilayer material.

16. The method of claim 12, further comprising cross-linking at least a portion of the uncross-linked rubber film and/or the physically cross-linked thermoplastic polymer films after confining the uncross-linked rubber film.

17. The method of claim 10, wherein the physically cross-linked thermoplastic polymer layers and uncross-linked rubber layer each have loss tangents (tan δs) that are substantially the same at temperatures of about −40° C. to about 50° C.

18. The method of claim 10, wherein the at least one physically cross-linked thermoplastic polymer film is a physically cross-linked thermoplastic elastomer selected from a styrenic block copolymer elastomer (TPS), a thermoplastic polyolefin elastomer (TPO), a thermoplastic polyurethane (TPU), a thermoplastic copolyester (TPC), a thermoplastic polyamide (TPA), or silicone copolymer elastomer.

19. The multilayer material of claim 10, wherein the at least one uncross-linked rubber film includes at least one of an uncross-linked natural rubber (NR) or a fully unvulcanized synthetic rubber.

20. An energy-damping and/or vibration dissipation material, formed by the method of claim 10.
